(19) United States
(12) Patent Application Publication
(10) Pub. No.: US 2013/0161373 A1
(43) Pub. Date: Jun. 27, 2013

(54) FASTENER DRIVE TOOL

(71) Applicant: Hilti Aktiengesellschaft, Schaan (LI)

(72) Inventor: Ulrich SCHIESTL, Hohenems (AT)

(73) Assignee: Hilti Aktiengesellschaft, Schaan (LI)

(21) Appl. No.: 13/713,338

(22) Filed: Dec. 13, 2012

(30) Foreign Application Priority Data
Dec. 23, 2011 (DE) 10 2011 089 725.9

(51) Int. Cl. B25C 1/00

(52) U.S. Cl. CPC B25C 1/00
USPC 227/146

(57) ABSTRACT

According to one feature of the present invention, the tool for driving a fastening element into a substrate comprises an energy transmission element for transmitting energy to the fastening element. The energy transmission element preferably moves between a starting position and a set position, with the energy transmission element being in the starting position prior to a fastener driving step and in the set position following the fastener driving step.

According to another feature of the present invention, the fastener drive tool comprises a mechanical energy storage means for storing mechanical energy. The energy transmission element can then be preferably used to transmit energy from the mechanical energy storage means to the fastening element.

### FIELD OF THE PRESENT INVENTION

The present invention relates to a tool for driving a fastening element into a substrate.

### BACKGROUND OF THE INVENTION

Tools of this type generally comprise a plunger for transmitting energy to the fastening element. The energy required therefore must be available within a very short time, which is the reason why, for example, spring-loaded nail guns require that first a spring be tensioned, which spring, during the fastener driving step, propels the tensioning energy at one blow to the plunger and accelerates said plunger in the direction of the fastening element.

In tools of this type, the energy, by means of which the fastening element is driven into the substrate, is bounded from above, thus not allowing the fastener drive tools to be used for all fastening elements and all substrates, it is therefore desirable to have fastener drive tools which are able to transmit sufficient energy to a fastening element.

### SUMMARY OF THE INVENTION

According to one feature of the present invention, the tool for driving a fastening element into a substrate comprises a mechanical energy storage means for storing mechanical energy, and an energy transmission element that moves along a set axis between a starting position and a set position so as to transmit energy from the mechanical energy storage means to the fastening element, with the mechanical energy storage means having a first helical spring, the helix of which defines a cylinder, the volume of which is disposed outside the set axis.

A preferred embodiment of the present invention is characterized in that the axis symmetry of the cylinder extends parallel to the set axis.

A preferred embodiment of the present invention is characterized in that in the starting position and/or in the set position, the energy transmission element, in the axial direction, is disposed at the same level as the first helical spring.

A preferred embodiment of the present invention is characterized in that the mechanical energy storage means comprises one or more additional helical springs, each helix of which defines a cylinder, the volume of which is disposed outside the set axis.

A preferred embodiment of the present invention is characterized in that the first and all additional helical springs are disposed so as to be uniformly distributed about the set axis.

According to a preferred embodiment of the present invention, the fastener drive tool comprises a force transducer element, especially a roller holder, for transducing the elastic force of the first and of at least one additional helical spring.

According to a preferred embodiment of the present invention, the fastener drive tool comprises a guide for the force transducer element.

A preferred embodiment of the present invention is characterized in that the force transducer element comprises especially an elastic compensation element for the first helical spring and/or for the additional helical springs.

A preferred embodiment of the present invention is characterized in that the first helical spring rotates in a first direction, and the additional helical spring rotates in a second direction which runs countercurrent with respect to the first direction. In this manner, potential negative influences of the direction of rotation are compensated for.

According to a preferred embodiment of the present invention, the fastener drive tool comprises an energy transmission mechanism for transmitting energy from an energy source to the mechanical energy storage means.

According to a preferred embodiment of the present invention, the fastener drive tool comprises a force transmission mechanism for transmitting a force from the energy transmission mechanism to the mechanical energy storage means and/or for transmitting a three from the energy storage means to the energy transmission element.

A preferred embodiment of the present invention is characterized in that the force transmission mechanism comprises a force reversing element for reversing the direction of a force transmitted by the force transmission mechanism.

A preferred embodiment of the present invention is characterized in that the force reversing element comprises a belt.

A preferred embodiment of the present invention is characterized in that the three reversing element extends within the helix of the first and/or additional helical spring.

A preferred embodiment of the present invention is characterized in that the energy transmission mechanism comprises a motion transducer for transducing a rotary movement into a linear movement and having a rotary input element and a linear output element, with the motion transducer being disposed on the set axis.

According to a preferred embodiment of the present invention, the fastener drive tool comprises a locking mechanism for temporarily locking the energy transmission element into the starting position, with the locking mechanism being disposed on the set axis.

According to a preferred embodiment of the present invention, the fastener drive tool comprises a tie rod for transmitting a tension force from the energy transmission mechanism, especially the linear output element and/or the rotary input element, to a locking mechanism, with the tie rod being disposed on the set axis.

A preferred embodiment of the present invention is characterized in that the force transmission mechanism, especially the force reversing element, in particular the belt, is affixed to the energy transmission mechanism, especially to the linear output element.

A preferred embodiment of the present invention is characterized in that the energy transmission mechanism can be used to move the energy transmission element from the set position into the starting position.

According to one feature of the present invention, a tool for driving a fastening element into a substrate comprises a mechanical energy storage means for storing mechanical energy and an energy transmission mechanism for transmitting energy from an energy source to the mechanical energy storage means, with the energy transmission mechanism comprising a first energy infeed mechanism for transmitting energy from an energy source to the mechanical energy storage means and a second energy infeed mechanism different from the first energy infeed mechanism for transmitting energy from the energy source to the mechanical energy storage means.

According to a preferred embodiment of the present invention, the fastener drive tool comprises an energy transmission element which can be moved along a set axis between a starting position and a set position for transmitting energy from the mechanical energy storage means to the fastening element.

A preferred embodiment of the present invention is characterized in that the energy transmission mechanism comprises a force transmission mechanism for transmitting a force from the energy storage means to the energy transmission element and/or for transmitting a force from the energy transmission mechanism, in particular from the first and/or the second energy infeed mechanism, to the mechanical energy storage means.

A preferred embodiment of the present invention is characterized in that the energy transmission mechanism comprises a force reversing element, with the three reversing element especially comprising a belt or a rope.

A preferred embodiment of the present invention is characterized in that the first energy infeed mechanism is suitable for moving the energy transmission element from the set position into the starting position.

A preferred embodiment of the present invention is characterized in that the second energy infeed mechanism is suitable for transmitting energy to the mechanical energy storage means and/or for drawing energy from the mechanical energy storage means without moving the energy transmission element.

A preferred embodiment of the present invention is characterized in that the energy transmission mechanism comprises a follower element which, to move the energy transmission element from the set position into the starting position, can be made to interlock with the energy transmission element.

A preferred embodiment of the present invention is characterized in that the enemy transmission mechanism comprises a motor with a motor output element, especially with the motor being an integral part of the first and the second energy infeed mechanism

A preferred embodiment of the present invention is characterized in that the energy transmission mechanism comprises a torque transmission mechanism for transmitting a torque from the motor output element, especially with the torque transmission mechanism being an integral part of the first and the second energy Weed mechanism.

A preferred embodiment of the present invention is characterized in that the torque transmission mechanism comprises a gear with a gear input element, a first gear output element and a second gear output element, especially with the first gear output element being an integral part of only the first energy infeed mechanism, the second gear output element being an integral part of only the second energy infeed mechanism, and with the gear input element being an integral part of the first and the second energy infeed mechanism.

A preferred embodiment of the present invention is characterized in that the gear comprises a planetary gear, with the gear input element preferably have the form of a sun wheel of the planetary gear, with the first gear output element having the form of a hollow wheel of the planetary gear, and with the second gear output element having the form of a planetary wheel of the planetary gear.

A preferred embodiment of the present invention is characterized in that the first and/or the second gear input element comprise(s) an arresting brake device and/or a freewheel mechanism.

A preferred embodiment of the present invention is characterized in that the first energy infeed mechanism comprises a motion transducer for transducing a rotary movement into a linear movement with a rotary input element that is actuated by the motor and a linearly moving linear output element, with the rotary input element preferably being formed by the first gear output element.

A preferred embodiment of the present invention is characterized in that the rotary input element comprises a toothed wheel and the linear output element comprises a gear rack.

A preferred embodiment of the present invention is characterized in that the linear output element comprises the follower element.

A preferred embodiment of the present invention is characterized in that the energy transmission element is linearly actuated by the linear output element or forms the linear output element.

A preferred embodiment of the present invention is characterized in that the force transmission mechanism comprises a take-up wheel for winding the force reversing element, with the take-up reel being actuated by the second infeed mechanism, in particular by the second gear output element, so as to transmit energy to the mechanical energy storage means.

A preferred embodiment of the present invention is characterized in that the mechanical energy storage means serves to store potential energy and preferably comprises a spring, preferably a helical spring.

A preferred embodiment of the present invention is characterized in that two, preferably oppositely lying, ends of the spring can be moved so as to tension the spring.

A preferred embodiment of the present invention is characterized in that the spring comprises two spring elements that are spaced apart and braced against each other.

According to one feature of the present invention, a tool for driving a fastening element into a substrate comprises an energy transmission element that moves along a set axis between a starting position and a set position so as to transmit energy to the fastening element and an energy transmission mechanism for moving the energy transmission element from the set position into the starting position, with the energy transmission mechanism comprising a follower spring and a follower element which can be made to interlock with the energy transmission element so as to move the energy transmission element from the set position into the starting position and which, prior to a movement of the energy transmission element from the starting position into the set position, can be reset by means of a force of the follower spring.

A preferred embodiment of the present invention is characterized in that during resetting by means of the force of the follower spring, the follower element moves at a higher speed than during the movement of the energy transmission element from the set position into the starting position.

A preferred embodiment of the present invention is characterized in that the follower element moves against the elastic force of the follower spring so as to move the energy transmission element from the set position into the starting position.

According to a preferred embodiment of the present invention, the fastener drive tool comprises a mechanical energy storage means for storing mechanical energy, the mechanical energy storage means preferably being a potential energy storage means and preferably having the form of a spring.

A preferred embodiment of the present invention is characterized in that the movement of the energy transmission element from the set position into the starting position serves to transmit energy to the mechanical energy storage means.

A preferred embodiment of the present invention is characterized in that the fastener drive tool comprises a locking mechanism for temporarily locking the energy transmission element into the starting position, with the locking mechanism being suitable for temporarily locking the energy transmission element preferably only into the starting position.

A preferred embodiment of the present invention is characterized in that the locking mechanism is disposed on the set axis or essentially symmetrically about the set axis.

A preferred embodiment of the present invention is characterized in that the follower element can be reset by the force of the follower spring while the energy transmission element is locked into the starting position by the locking mechanism.

A preferred embodiment of the present invention is characterized in that the follower element merely rests against the enemy transmission element.

A preferred embodiment of the present invention is characterized in that the follower element comprises a longitudinal body, in particular a rod.

A preferred embodiment of the present invention is characterized in that the energy transmission mechanism comprises a linearly moving linear output element which comprises the follower element and which is connected to the force transmission mechanism.

According to one feature of the present invention, a tool tor driving a fastening element into a substrate comprises a mechanical energy storage means for storing mechanical energy and an energy transmission mechanism for transmitting energy from an energy source to the mechanical energy storage means, with the energy transmission mechanism comprising a tensioning element that moves between an untensioned position and a tensioned position, said tensioning element moving at a higher speed along the path from the tensioned position into the untensioned position than along the path from the untensioned position into the tensioned position.

A preferred embodiment of the present invention is characterized in that in order to transmit energy to the mechanical energy storage means, the tensioning element can be moved from the untensioned position into the tensioned position.

A preferred embodiment of the present invention is characterized in that the energy transmission mechanism comprises a motor for actuating the tensioning element.

A preferred embodiment of the present invention is characterized in that the motor moves at the same speed when actuating the tensioning element on its path from the tensioned position into the untensioned position as it does when it actuates the tensioning element on its path from the untensioned position into the tensioned position.

A preferred embodiment of the present invention is characterized in that the energy transmission mechanism comprises a locking gear with a locking gear input element and a locking gear output element, with the locking gear output element actuating or forming the tensioning element.

A preferred embodiment of the present invention is characterized in that the locking gear input element can be actuated by the motor.

A preferred embodiment of the present invention is characterized in that the tensioning element can be linearly moved back and forth between the untensioned position and the tensioned position.

According to a preferred embodiment of the present invention, the fastener drive tool comprises an energy transmission element that moves along a set axis between a starting position and a set position so as to transmit energy from the mechanical energy storage means to the fastening element.

A preferred embodiment of the present invention is characterized in that the energy transmission element is moved from the set position into the starting position when the tensioning element is moved from the untensioned position into the tensioned position.

A preferred embodiment of the present invention is characterized in that the energy transmission element is moved from the set position into the starting position when the tensioning element is moved from the tensioned position into the untensioned position.

A preferred embodiment of the present invention is characterized in that the energy transmission mechanism comprises a follower element which is moved by or comprised in the tensioning element and which can be made to interlock with the energy transmission element so as to move the enemy transmission element from the set position into the starting position.

A preferred embodiment of the present invention is characterized in that the follower element is reset when the tensioning element is moved from the untensioned position into the tensioned position.

A preferred embodiment of the present invention is characterized in that the follower element is reset when the tensioning element is moved from the tensioned position into the untensioned position.

A preferred embodiment of the present invention is characterized in that the mechanical energy storage means serves to store potential energy and preferably comprises a spring, preferably a helical spring.

According to one feature of the present invention, a tool for driving a fastening element into a substrate comprises an energy transmission element for transmitting energy to the fastening element. The energy transmission element preferably moves between a starting position and a set position, with the energy transmission element prior to a fastener driving step being in the starting position and after the fastener driving step being in the set position.

According to one feature of the present invention, the fastener drive tool comprises a mechanical energy storage means for storing mechanical energy. The energy transmission element is then suitable especially for transmitting energy from the mechanical energy storage means to the fastening element.

According to one feature of the present invention, the fastener drive toot comprises an energy transmission mechanism for transmitting energy from an energy source to the mechanical energy storage means. The energy for a fastener driving step is preferably buffered in the mechanical storage means and is subsequently propelled at one blow to the fastening element. The energy transmission mechanism is preferably used to move the energy transmission element from the set position into the starting position. The energy source is preferably an electrical energy storage means, most preferably a battery or a secondary storage battery. The fastener drive tool preferably comprises an energy source.

According to one feature of the present invention, the energy transmission mechanism can be used to move the energy transmission element from the set position into the direction of the starting position without transmitting energy to the mechanical energy storage means. This allows the mechanical energy storage means to absorb and/or release energy without moving the energy transmission element into the set position. This means that the energy storage means can be discharged without ejecting a fastening element from the fastener drive tool.

According to one feature of the present invention, the energy transmission mechanism can be used to transmit energy to the mechanical energy storage means without moving the energy transmission element.

According to one feature of the present invention, the energy transmission mechanism comprises a force transmission mechanism for transmitting a force from the energy storage means to the energy transmission element and/or for transmitting a force from the energy transmission mechanism to the mechanical energy storage means.

According to one feature of the present invention, the energy transmission mechanism comprises a follower element which can be made to interlock with the energy transmission element so as to move the energy transmission element from the set position into the starting position.

The follower element preferably allows the energy transmission element to move from the starting position into the set position. The follower element preferably merely rests against the energy transmission element so that the follower element takes the energy transmission element only in one of two oppositely directed directions of movement.

According to one feature of the present invention, the energy transmission mechanism comprises an energy infeed mechanism for transmitting energy from an energy source to the mechanical energy storage means and a return mechanism which is separate from and works independently of the energy infeed mechanism for moving the energy transmission element from the set position into the starting position.

According to one feature of the present invention, the fastener drive tool comprises a locking mechanism for temporarily locking the energy transmission element into the starting position. The locking mechanism can preferably be used to temporarily lock the energy transmission element only into starting position.

According to one feature of the present invention, the fastener drive tool comprises an energy transmission mechanism with a linearly movable linear output element for moving the energy transmission element from the set position into the starting position in the direction of the locking mechanism.

The energy transmission element is preferably a rigid body.

According to one feature of the present invention, the fastener drive tool comprises a locking mechanism for temporarily locking the energy transmission element into the starting position and a tie rod for transmitting a tension force from the energy transmission mechanism, in particular the linear output element and/or the rotary input element, to the locking mechanism.

According to one feature of the present invention, the energy transmission element also comprises a plug-in locking component for temporarily locking it to a locking mechanism.

According to one feature of the present invention, the fastener drive tool comprises a delay element for delaying the energy transmission element, The delay element preferably has a stop face for the energy transmission element.

According to one feature of the present invention, the fastener drive tool comprises the energy source.

According to one feature of the present invention, the energy source is an electrical energy storage means.

### BRIEF DESCRIPTION OF THE SEVERAL VIEWS OF THE DRAWING(S)

Embodiments of a tool for driving a fastening element into a substrate will be described in greater detail below with reference to application examples shown in the drawings. As can be seen:

FIG. 1 shows a lateral view of a fastener drive tool,

FIG. 2 shows a lateral view of a fastener drive tool with an open housing,

FIG. 3 shows an oblique view of an energy transmission mechanism,

FIG. 4(A-D) shows a schematic representation of a fastener drive tool, and

FIG. 5(A-B) shows a schematic representation of a fastener drive tool.

### DETAILED DESCRIPTION OF THE INVENTION

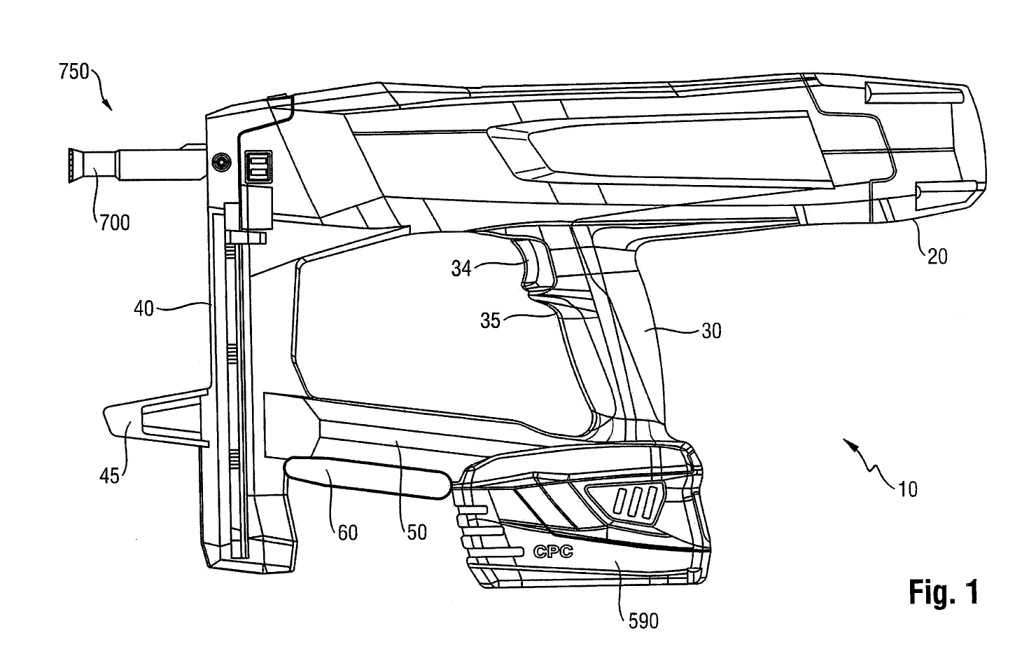

FIG. 1 shows a lateral view of a fastener drive tool 10 for driving a fastening element, for example, a nail or bolt, into a substrate. The fastener drive tool 10 comprises an energy transmission element (not shown) for transmitting energy to the fastening element and a housing 20 which holds the energy transmission element and an actuator (not shown) for moving the energy transmission element.

In addition, the fastener drive tool 10 comprises a grip handle 30, a magazine 40 and a bridge-like element 50 that connects the grip handle 30 to the magazine 40. The magazine cannot be removed. Attached to the bridge-like element 50 are a scaffold hook 60 for hanging the fastener drive tool 10 on a scaffold or the like, and an electrical energy storage means in the form of a secondary storage battery 590. Disposed on the grip handle 30 are a trigger 34 and a grip sensor in the form of a manual switch 35, in addition, the fastener drive tool 10 comprises a guide channel 700 for guiding the fastening element and a contact means 750 for identifying a distance of the fastener drive tool 10 from a substrate (not shown). The use of an alignment aid 45 helps to align the fastener drive tool perpendicular to a substrate.

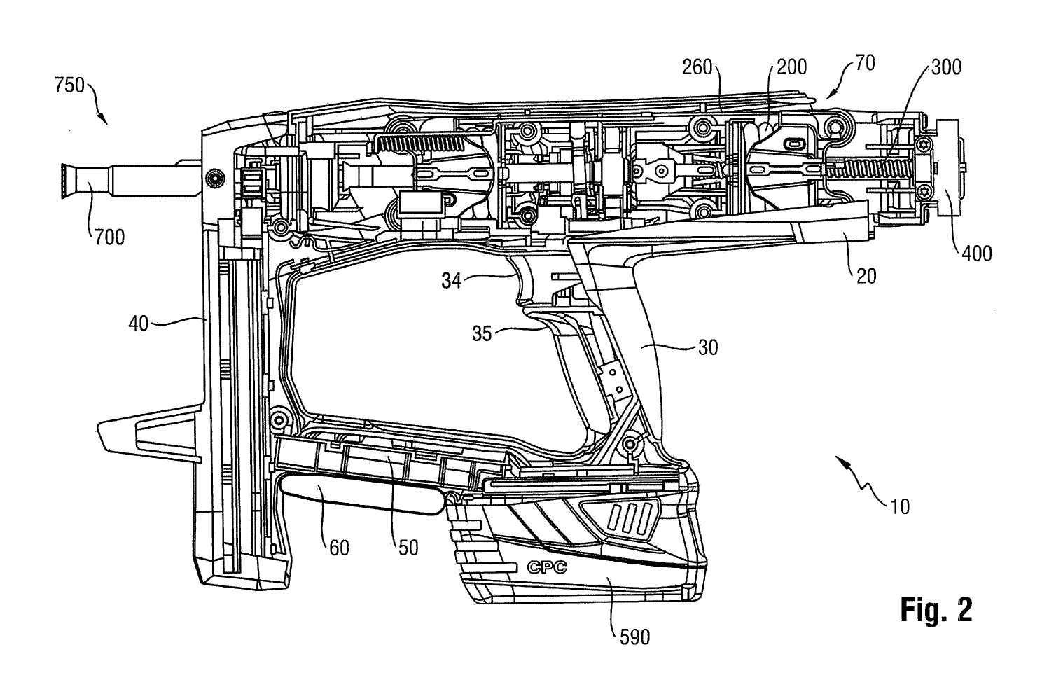

FIG. 2 shows the fastener drive tool 10 with an open housing 20. The housing 20 accommodates an actuating mechanism 70 for moving an energy transmission element that is hidden in the drawing. The actuating mechanism 70 comprises an electromotor (not shown) for transducing electrical energy from a secondary storage battery 590 into rotary energy, a torque transmission mechanism comprising a gear 400 for transmitting a torque of the electromotor to a motion transducer in the form of a spindle drive 300, a force transmission mechanism comprising a pulley block 260 for transmitting a three from the motion transducer to a mechanical energy storage means in the form of a spring 200 and for transmitting a force from the spring to the energy transmission element.

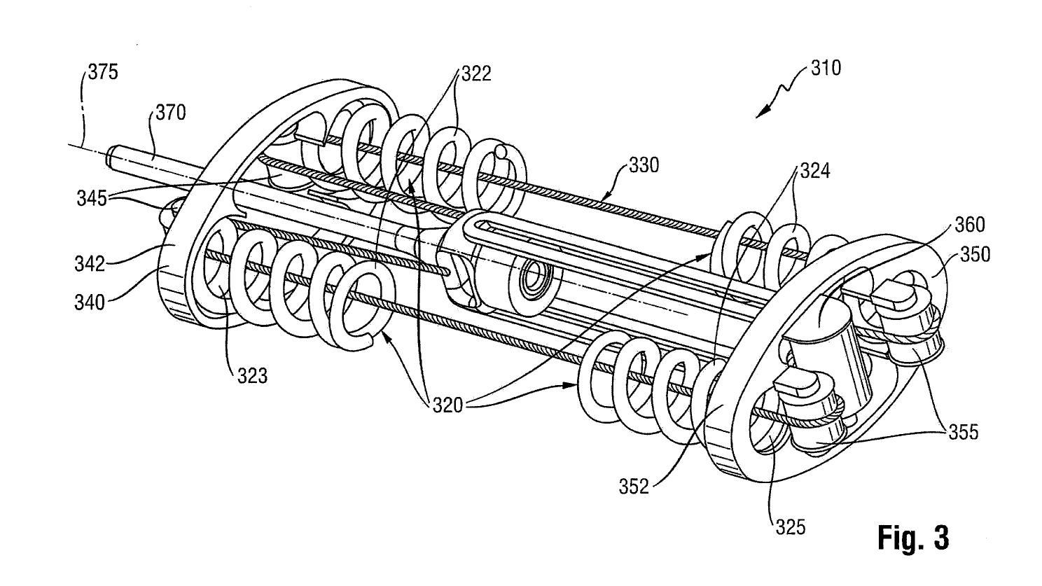

FIG. 3 shows an oblique view of a force transmission mechanism in the form of a pulley block 310 for transmitting a force to a spring 320. The pulley block 310 comprises a throe reversing element in the form of a belt 330 and a front roller holder 340 with front rollers 345 and a rear roller holder 350 with rear rollers 355. The roller holders 340,350 are most preferably made of a fiber-reinforced synthetic material. The roller holders 340,350 comprise guide rails 342,352 for guiding the roller holders 340,350 inside a housing (not shown) of the fastener drive tool, in particular in grooves of the housing, which prevents the risk of tilting. The belt 330 interlocks with a follower element 360 and a plunger 370 and is guided via rollers 345,355, thereby forming the pulley block 310. The plunger 370 is locked and held in a locking mechanism (not shown). The plunger 370 always moves back and forth along a set axis 375 on which the locking mechanism is preferably disposed.

In addition, the figure shows a spring 320 which comprises two front spring elements 322 and two rear spring elements 324. The front spring ends 323 of the front spring elements 322 are disposed in the front roller holder 340, and the rear spring ends 325 of the rear spring elements 324 are disposed in the rear roller holder 350, thereby allowing the roller holders 340,350 to absorb forces of the spring elements 322,324. On the ends facing each other, the spring elements 322,324 are supported by support rings (not shown). Due to the symmetrical arrangement of the spring elements 322,324, recoil forces of the spring elements 322,324 are neutralized, which improves the ease of operating the fastener drive tool. The pulley block transforms a relative speed of the spring ends 230,240 into a speed of the plunger 100 by a factor of 2, i.e., it transforms the speed of each of the spring ends 230,240 into a speed of the plunger 100 by a factor of four.

Each of the spring elements 322,324 has the form of a helical spring, the helix of which defines a cylinder, the volume of which is disposed outside the set axis and the axis of symmetry of which runs parallel to the set axis, with the front spring elements 322 being disposed opposite to each other with respect to the set axis 375. Similarly, the rear spring elements 324 are disposed on the opposite sides of the set axis 375. In the axial direction 375, the energy transmission element 370 is disposed at the same level as the front spring elements 322, The belt 330 extends inside the spring elements 322, 324, that is to say inside the cylinders defined by these belts, which saves space. To compensate for production tolerances in the length of the individual spring elements 322,324, the roller holders 340,350 comprise compensation elements (not shown).

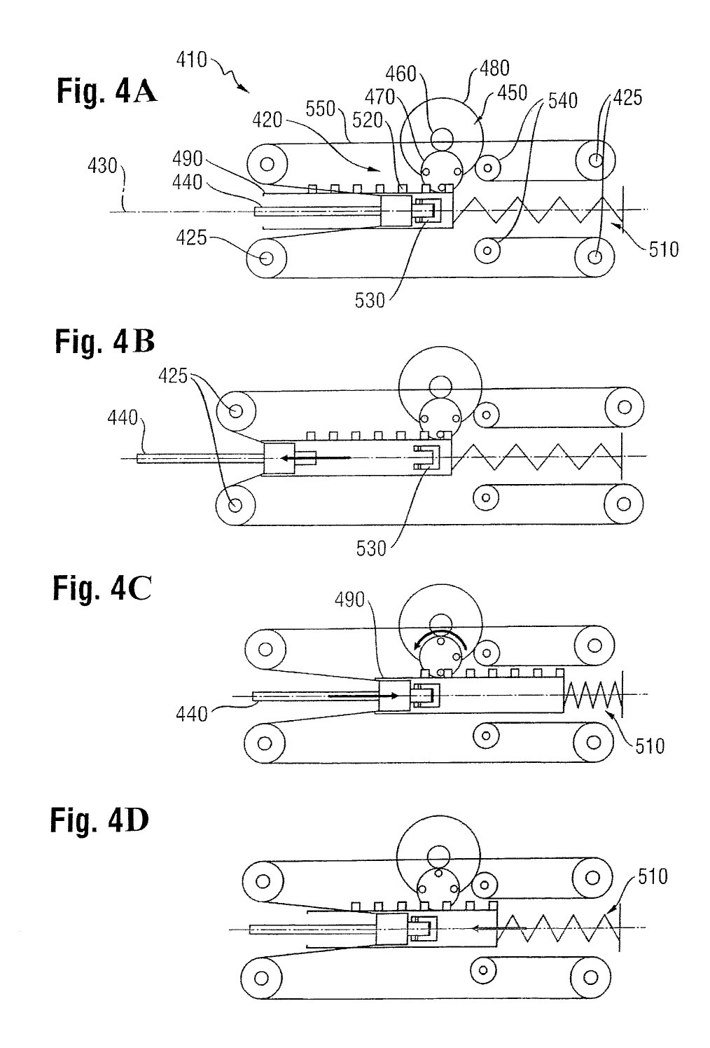

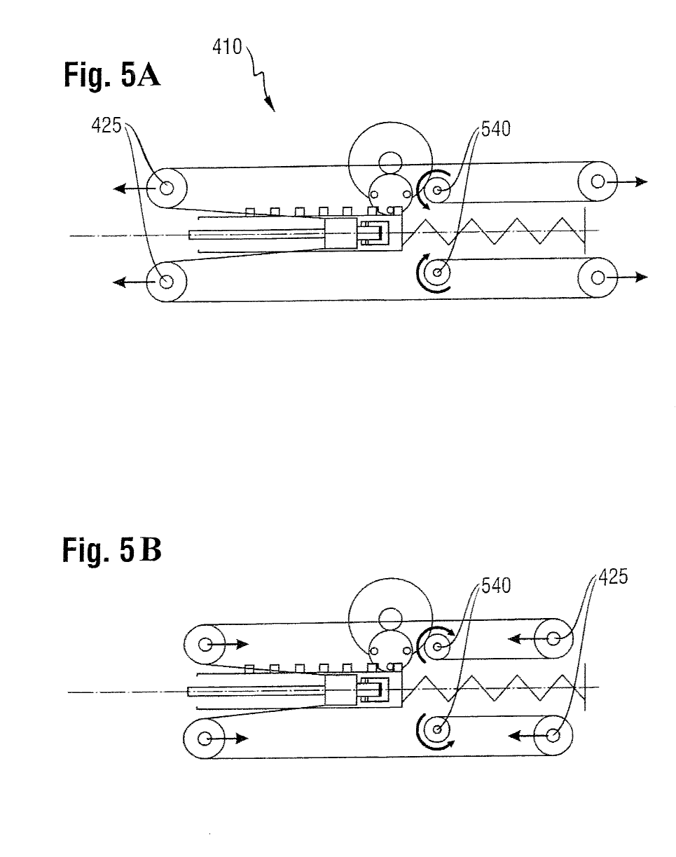

FIGS. 4 and 5 show a schematic representation of a fastener drive tool 410 having a mechanical energy storage means (not shown) for storing mechanical energy and an energy transmission mechanism 420 for transmitting energy from an energy source (not shown) to the mechanical energy storage means. The fastener drive tool 410 comprises an energy transmission element 440 which moves along a set axis 430 between a starting position and a set position for transmitting energy from the mechanical energy storage means to a fastening element (not shown). The mechanical energy storage means preferably has the form of a spring, with the two oppositely disposed ends of the spring being moved by means of roller holders 425 so as to tension the spring. The spring preferably comprises two spring elements that are spaced apart and preferably braced against each other.

The energy transmission mechanism 420 comprises a first energy infeed mechanism for transmitting energy from an energy source to the mechanical energy storage means and a second energy infeed mechanism different from the first energy infeed mechanism for transmitting energy from the energy source to the mechanical energy storage means. The first and the second energy infeed mechanism jointly comprise a force reversing element in the form of a belt 450, a motor (not shown) with a motor output element and a gear input element of a planetary gear 450 of a torque transmission mechanism (not shown), said gear input element having the form of a sun wheel 460.

In addition, the first energy infeed mechanism comprises a first gear output element in the form of a hollow wheel 480 of the planetary gear 450, a freewheel mechanism (not shown), a follower element 490 and a motion transducer for transducing a rotary movement into a linear movement with a rotary input element in the form of a hollow wheel 480 and a linearly movable linear output element which comprises a toothed rack that is formed by a follower element 520. The first energy infeed mechanism serves to move the energy transmission element from the set position into the starting position.

In addition, the energy transmission mechanism 420 also comprises a follower spring 510, the force of which resets the follower element as soon as during a tensioning step, the energy transmission element 440 is locked by a locking mechanism 530 and the follower element is released. To this end, during the tensioning step, the follower element is moved against the elastic force of the follower spring. During the tensioning step, the energy transmission element is moved from the set position into the starting position, so as to transmit energy via a force reversing element in the form of a belt 550 to the mechanical energy storage means. It suffices if the follower element 490 merely rests against the energy transmission element 440 so as to be able to transmit energy to the mechanical energy storage means via the hollow wheel 480, the toothed rack 520, the follower element 490, the energy transmission element 440, the belt 530 and the roller holder 425. To this end, the follower element 490 has the form of a rod with hooks.

The second energy infeed mechanism, on the other hand, comprises a second gear output element in the form of a planetary wheel 470 of the planetary gear 450, an arresting brake device (not shown) and a take-up reel 540 for winding the belt 550. The second energy infeed mechanism serves to transmit energy to the mechanical energy storage means and to draw energy from the mechanical energy storage means without moving the energy transmission element.

FIGS. 4A)-4D) illustrate a standard operating cycle during which a fastening element is driven into a substrate. In set direction “front” always means left.

In FIG. 4A), the springs are tensioned, the energy transmission element 440 is locked in its starting position by the locking mechanism 530, and the follower element 490 is in its foremost position. At the end of the fastener driving step, the fastener drive tool 410 is in the position shown in FIG. 4B). The springs are untensioned, and the energy transmission element 440 is in the set position in which the follower element 490 rests against the energy transmission element 440. To tension the springs, the energy transmission element 440 is subsequently moved back into the starting position by means of the first energy infeed mechanism, i.e., via the hollow wheel 480 and the follower element 490 (FIG. 4C)). As soon as the energy transmission element 440 is locked into the locking mechanism 530, the follower element 490 is released because of the absence of a tooth on the hollow wheel 480 and is moved forward by the follower spring 510 (FIG. 4D)). This toothed rack gear transduces the rotary movement of the planetary gear 450 into a linear movement of the follower element 490, with the gear teeth at the end of the tensioning movement of the follower element 490 being because of the absence of the tooth, thus making it possible for the follower element 490 that is spring-loaded by the follower spring 510 to spring back into the front position.

FIGS. 5A) and 5B) illustrate how the springs are untensioned and subsequently tensioned when the energy transmission element 440 does not move, for example, when the fastener drive tool 410 is switched off and subsequently on again. In set position, “front” always means left.

As shown in FIG. 5A), when switching off the fastener drive tool 410, the take-up reels, which to this end are connected to each other by means of a toothed gear (not shown), are propelled by the springs into the direction shown, with the arresting brake device being released for this purpose, thereby drawing the energy from the springs and transmitting it to the motor. In this case, the motor serves as a motor brake. The energy transmission element 540 remains in its starting position. As soon as the fastener drive tool 410 is switched on again, the motor actuates the take-up reels 540 via the planetary wheel 470 into the direction shown in FIG. 5B), thereby retensioning the springs.

1. A tool for driving a fastening element into a substrate, comprising an energy transmission element that moves along a set axis between a starting position and a set position so as to transmit energy to the fastening element, and an energy transmission mechanism for moving the energy transmission element from the set position into the starting position, the energy transmission mechanism comprising a follower spring and a follower element which are interlockable with the energy transmission element so as to move the energy transmission element from the set position into the starting position and which, prior to a movement of the energy transmission element, can be reset from the starting position into the set position by the force of the follower spring.

2. The fastener drive tool as in claim 1, wherein the follower element, during the resetting by the force of the follower spring, moves at a higher speed than during the movement of the energy transmission element from the set position into the starting position.

3. The fastener drive tool as in claim 1, wherein the follower element is moved against elastic force of the follower spring to move the energy transmission element from the set position into the starting position.

4. The fastener drive tool as in claim 1, further comprising a mechanical enemy storage means for storing mechanical energy.

5. The fastener drive tool as in claim 1, wherein the movement of the energy transmission element from the set position into the starting position transmits energy to the mechanical energy storage means.

6. The fastener drive tool as in claim 1, wherein the tool comprises a locking mechanism for temporarily locking the energy transmission element into the starting position.

7. The fastener drive tool as in claim 6, wherein the locking mechanism is disposed on the set axis or essentially symmetrically about the set axis.

8. The fastener drive tool as in claim 6, wherein the follower element can be reset by the force of the follower spring while the energy transmission element is locked by the locking mechanism into the starting position.

9. The fastener drive tool as in claim 1, wherein the follower element against the energy transmission element.

10. The fastener drive tool as in claim 1, wherein the follower element comprises a longitudinal body.

11. The fastener drive tool as in claim 1, wherein the energy transmission mechanism comprises a linearly movable linear output element which comprises the follower element and which is connected to the force transmission mechanism.

12. The fastener drive tool as in claim 4, wherein the mechanical storage means comprises a potential energy storage means comprising a spring.

13. The fastening tool as in claim 6, wherein the locking mechanism temporarily locks the energy transmission element only into the starting position.

14. The fastener drive tool according to claim 10, wherein the longitudinal body comprises a rod.

15. The fastener drive tool as in claim 2, wherein the follower element is moved against elastic force of the follower spring in order to move the energy transmission element from the set position into the starting position.

16. The fastener drive tool as in claim 2, further comprising a mechanical energy storage means for storing mechanical energy.

17. The fastener drive tool as in claim 3, further comprising a mechanical energy storage means tor storing mechanical energy.

18. The fastener drive tool as in claim 2, wherein the movement of the energy transmission element from the set position into the starting position transmits energy to the mechanical energy storage means.

19. The fastener drive tool as in claim 3, wherein the movement of the energy transmission element from the set position into the starting position transmits energy to the mechanical energy storage means.

20. The fastener drive tool as in claim 4, wherein the movement of the energy transmission element from the set position into the starting position transmits energy to the mechanical energy storage means.
